(19) United States
(12) Patent Application Publication
(10) Pub. No.: US 2023/0340347 A1
(43) Pub. Date: Oct. 26, 2023

(54) PROCESS FOR PRODUCTION OF SYNGAS AND FUELS FROM CARBON DIOXIDE USING OXYFUEL COMBUSTION

(71) Applicant: Infinium Technology, LLC, Sacramento, CA (US)

(72) Inventors: JAMES BUCHER, Boston, MA (US); MATTHEW CALDWELL, West Sacramento, CA (US); ORION HANBURY, Sacramento, CA (US); ROBERT SCHUETZLE, Sacramento, CA (US); DENNIS SCHUETZLE, Grass Valley, CA (US); ANJA RUMPLECKER GALLOWAY, San Rafael, CA (US)

(73) Assignee: Infinium Technology, LLC, Sacramento, CA (US)

(21) Appl. No.: 18/445,119

(22) Filed: Apr. 14, 2023

Related U.S. Application Data
(60) Provisional application No. 63/372,986, filed on Apr. 20, 2022.

(51) Int. Cl. C10L 3/08; C07C 1/12

(52) U.S. Cl. CPC C10L 3/08; C07C 1/12; C10L 2200/0415; C10L 2290/02

(57) ABSTRACT

Syngas and liquid hydrocarbons are produced from synthesis gas. The synthesis gas is produced from a feed mixture of hydrogen and carbon dioxide. The feed mixture is heated to the reverse water gas shift (RWGS) reactor inlet temperature of 1400 to 1800° F. or even more preferred to a RWGS reactor inlet temperature of 1550 to 1650° F. Some of the heat required to heat the feed mixture to the RWGS inlet temperature is supplied by the oxyfuel combustion of hydrogen or fuel with oxygen and minimizes the load onto electrical heaters or need for gas fired geaters. The high inlet temperature allows a high conversion of carbon dioxide to carbon monoxide. Various fuels can be used including hydrogen, hydrocarbons, oxygenates, or carbon monoxide can be used as combustion fuel. The carbon monoxide produced can further be reacted with hydrogen to produce hydrocarbon fuels and chemicals. The hydrocarbon fuels produced include sustainable aviation fuel (SAF) that meets ASTM D7566 specification and diesel fuel that meets ASTM D975 specification. The hydrogen and oxygen are produced from the electrolysis of water. The carbon dioxide can be captured from industrial point sources such as power plants, ethanol plants, steel mills, or other producers of carbon dioxide. Alternatively, the carbon dioxide can be captured from the atmosphere.

### CROSS-REFERENCE TO RELATED APPLICATION

This application claims priority benefit of U.S. Provisional Patent Application No. 63/372,986, filed Apr. 20, 2022, the entire content of which is hereby incorporated by reference into this document.

### FIELD OF THE INVENTION

The present invention generally relates to the production of syngas and liquid hydrocarbon fuels from carbon dioxide and hydrogen integrated with an oxyfuel combustion system.

### BACKGROUND OF THE INVENTION

The increase in global atmospheric carbon dioxide concentrations has been linked to changes in the earth's climate. The combustion of fossil fuels in various engines produces atmospheric carbon dioxide. Concerns about climate change have led to significant societal changes toward renewable or low carbon electricity. This has also led to increasing activity to decarbonize the transport sector of the economy. As a result, we see increases in the use of electric vehicles that are powered by renewable electricity to aid in decarbonization of the transport sector. Heavy transport and aviation are some of the most carbon intensive transportation sectors. Efficient and economical production of low carbon fuels, diesel, and sustainable aviation fuel could lead to significant reductions in the carbon dioxide emissions by the heavy transport and the aviation sectors.

### BRIEF SUMMARY OF THE INVENTION

Liquid hydrocarbons are produced from synthesis gas. The synthesis gas is produced from a feed mixture of hydrogen and carbon dioxide. The feed mixture is heated to the reverse water gas shift (RWGS) reactor inlet temperature of 1200 to 2000° F., or even more preferred is a RWGS reactor inlet temperature of 1550′to 1650° F. Some or all of the heat required to heat the feed mixture to the RWGS inlet temperature is supplied by the oxyfuel combustion of hydrogen or fuel with oxygen and minimizes the load onto electrical heaters, the need for gas fired heaters, or other methods of heating that add cost and/or add carbon emissions to the process. The use of oxycombustion can greatly simplify the production of liquid hydrocarbons from carbon dioxide. The high inlet temperature allows a high conversion of carbon dioxide to carbon monoxide. Various fuels can be used as combustion fuel, including hydrogen, hydrocarbons, oxygenates, and carbon monoxide. The carbon monoxide produced can further be reacted with hydrogen to produce hydrocarbon fuels and chemicals. The hydrocarbon fuels produced include sustainable aviation fuel (SAF) that meets ASTM D7566 specification, diesel fuel that meets ASTM D975 specification, naphthas, methanol, synthetic natural gas and other fuel and chemical products that ordinarily would be derived from petroleum or other fossil resources.

The hydrogen and oxygen can be produced from the electrolysis of water. The carbon dioxide can be captured from industrial point sources such as power plants, ethanol plants, steel mills, refineries, chemical facilities or other producers of carbon dioxide. Alternatively, the carbon dioxide can be captured from the atmosphere using Direct Air Capture (DAC).

Certain patent applications deal with the production of fuels and chemicals from carbon dioxide and low carbon fuel including U.S. patent application Ser. No. 17/300,259, U.S. patent application Ser. No. 17/300,260, U.S. patent application Ser. No. 17/300,262, U.S. patent application Ser. 16/873,561, U.S. Patent Application 63/101,555, U.S. Patent Application 63/101,556, and U.S. patent application Ser. No. 17/300,261. Each application is incorporated by reference in its entirety.

### BRIEF DESCRIPTION OF THE DRAWINGS

FIG. 1 shows a block flow diagram showing the production of syngas from a mixture of hydrogen and carbon dioxide.

FIG. 2 shows a block flow diagram showing the production of hydrocarbons from a mixture of hydrogen and carbon dioxide.

FIG. 3 shows a block flow diagram showing the production of syngas from a mixture of hydrogen and carbon dioxide using two RWGS reactors, in series.

FIG. 4 shows a block flow diagram showing low carbon electricity to produce hydrogen and with carbon dioxide to produce hydrocarbon products.

FIG. 5 shows a diagram showing an integrated mixer/combustor/RWGS reactor to produce carbon monoxide from carbon dioxide.

### DETAILED DESCRIPTION OF THE INVENTION

Low carbon power or electricity can be used to produce hydrogen from water. Low carbon electricity includes but is not limited to wind power, solar power, nuclear power, power generated from biomass or renewable natural gas, and hydropower. Hydrogen is produced by electrolysis of water.

H₂O═H₂+½O₂ Eq. 1

Electrolyzers consist of an anode and a cathode separated by an electrolyte. Different electrolyzers function in slightly different ways. Different electrolyzer designs that use different electrolysis technology include alkaline electrolysis, polymer electrolyte membrane (PEM) electrolysis, solid oxide electrolysis, high temperature electrolysis and other emerging types of electrolysis. Different electrolytes that are used including liquid KOH and NaOH, with or without activating compounds. Activating compounds may be added to the electrolyte to improve the stability of the electrolyte. Most ionic activators for the hydrogen evolution reaction are composed of an ethylenediamine-based metal chloride complex ([M(en)3]Clx,M¼Co, Ni, et al.) and Na₂MoO₄ or Na₂WO₄. Different electrocatalysts are used on the electrodes including many different combinations of metals and oxides like Raney-Nickel-Aluminum, which are enhanced by adding cobalt or molybdenum to the alloy.

The products from the electrolyzer are a stream comprising hydrogen and a stream comprising oxygen. Due to the use of renewable energy sources, the electrolyzer produces green hydrogen. Other means of hydrogen generation are also useful in the invention including renewable methane pyrolysis, steam reforming of natural gas with or without carbon capture, biomass gasification, renewable natural gas (RNG) reforming, reforming of anaerobic digester gas or reforming of landfill gas, hydrogen produced from the thermal or catalytic decomposition of green ammonia, and sourcing hydrogen from geological sources where purification of the stream may be required to produce hydrogen for use in a process.

Carbon dioxide is obtained from several sources. Power plants that generate electricity from various carbonaceous resources produce large amounts of carbon dioxide. Industrial manufacturing plants that produce ammonia for fertilizer produce large amounts of carbon dioxide. Ethanol plants that convert corn or wheat into ethanol produce large amounts of carbon dioxide via fermentation. Other industrial fermentation processes also produce large amounts of carbon dioxide. Municipal sewage treatment systems using aerobic and anaerobic digestion of sludge produce large amounts of CO₂. Utilization or conversion of CO₂, as described herein, typically involves separating and purifying the CO₂ from a gaseous stream where the CO₂ is not the major component (e.g., exhaust flue gas). Typically, an alkylamine is used to remove the carbon dioxide from the gas stream. Alkylamines used in the process include monoethanolamine, diethanolamine, methydiethanolamine, disopropylamine, aminoethoxyethnol, or combinations thereof. Metal Organic Framework (MOF) materials have also been used as a means of separating carbon dioxide from a dilute stream using chemisorption or physisorption to capture the carbon dioxide from the stream. Other methods to get concentrated carbon dioxide include chemical looping combustion where a circulating metal oxide material captures the carbon dioxide produced during the combustion process. Carbon dioxide is also be captured from the atmosphere in what is called direct air capture (DAC). The processes for the capture of carbon dioxide often involve regeneration of the capture materials. Alkylamines are regenerated by being heated, typically by low pressure steam.

Captured carbon dioxide which is converted into useful products such as fuels (e.g. diesel fuel, gasoline blend stocks, jet fuel, methanol, synthetic natural gas, other) and chemicals (e.g. solvents, olefins, alcohols, aromatics, waxes, other), displace fuels and chemicals produced from fossil sources such as petroleum and natural gas, and accordingly lower the total net emissions of carbon dioxide into the atmosphere. This is what is meant by low carbon, very low carbon, zero carbon, or negative carbon fuels and chemicals.

The carbon dioxide streams that comes from industrial or biological process, or is captured from the atmosphere, or that is available from a commercial carbon dioxide pipeline is not pure carbon dioxide. These available carbon dioxide streams from industrial facilities or pipelines contain sulfur compounds from zero to 2000 parts per million by weight and also contain hydrocarbons from zero to 10 volume percent. Purification of the carbon dioxide including the removal of sulfur containing compounds and hydrocarbons is necessary to avoid issues with downstream processing. After purification, the purified carbon dioxide is suitable for the generation of low carbon or zero-carbon fuels and chemicals.

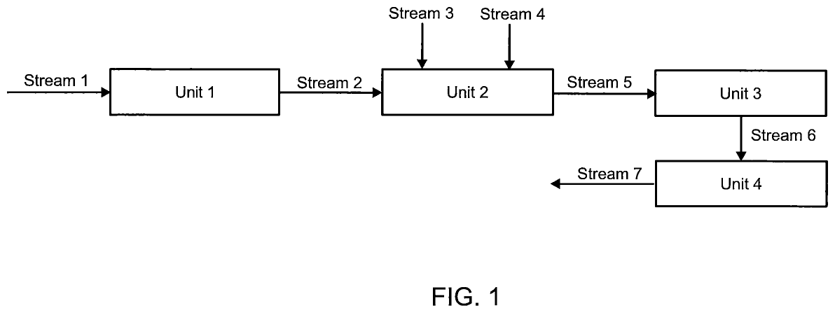

FIG. 1 shows one embodiment of the invention. The process feed stream, stream 1, comprising a mixture of hydrogen and carbon dioxide is at a temperature of between 70° F. and 200° F. and a pressure from 1 atmosphere to 30 atmospheres. Stream 1 is heated in a heat exchanger, unit 1, that heats up stream 1 to produce a new stream, stream 2, with a higher temperature of between 600° F. to 1100° F., or more preferably between 649° F. and 1001° F. The product stream leaving the heat exchanger is stream 2 which is the heated Reverse Water Gas Shift (RWGS) feed stream.

The heat exchanger, unit 1, can be chosen from any industrial heat exchangers including shell and tube heat exchangers, plate and frame heat exchangers, concurrent heat exchangers, co-current heat exchangers, and other means of indirect heat transfer. The heating medium of the heat exchanger can be any suitable medium but in one embodiment the heat transfer medium is chosen from a group consisting of RWGS reactor product, hot syngas, hot flue gas, hot oil, or steam.

The heated RWGS feed stream is still at a temperature lower than needed for the RWGS reaction. The Reverse Water Gas Shift (RWGS) reaction is:

H₂+CO₂↔H₂O+CO Eq. 2

The RWGS reaction is an endothermic equilibrium reaction that can be aided by a catalyst. The thermodynamic conversion of carbon dioxide is favored as the RWGS reactor inlet temperature increases. The RWGS reactor inlet temperature of 1200 to 2000° F. is preferred. An inlet temperature of 1550 to 1650° F. is even more preferred and allows the high conversion of carbon dioxide to carbon monoxide over the catalyst.

Heating the heated RWGS feed, stream 2, from the temperature of 600° F. to 1100° F. to the RWGS reactor inlet temperature of 1650 to 1750° F., requires addition energy. The preferred method to raise the temperature of that stream is to use energy from the combustion of hydrogen, carbon monoxide, or hydrocarbons that are added or found in the heated RWGS feed stream.

The oxidation of hydrocarbons, oxygenates, hydrogen, or carbon monoxide is exothermic and is represented in the following equation.

$${C}_{x} {H}_{y} {O}_{z} + ( x + \frac{y}{4} - \frac{z}{2} ) {O}_{2} = {xCO}_{2} + \frac{y}{2} {H}_{2} O \qquad Eq . 3$$

For example, for hydrogen combustion, in the above equation, x=0, y=2, and z=0. For the combustion of methane, a primary component in natural gas as well as landfill gas, x=1 and y=4, and z=0. For the combustion of carbon monoxide for example, x=1, y=0, and z=1. Fuel for the combustor can be chosen from any material consistent with the combustion equation and mixtures thereof For example, syngas, alkanes, alkenes, carbon monoxide, hydrogen, ethanol, methanol, and mixtures thereof can be used as fuel for the combustor. A small amount of fuel and oxygen can be burned or combusted and the hot CO₂ and H₂O can be blended in the RWGS feed and raise the overall temperature of the feed stream to at or near the RWGS reactor inlet temperature. Alternatively, additional hydrocarbon can be added to the heated RWGS feed and then mixed with a stream comprising oxygen to combust the hydrocarbon to raise the temperature of the stream. The mixer, unit 2, can be used to blend the oxygen, stream 3, with a fuel stream, stream 4, with stream 2. The mixer produces a mixed stream comprising hydrogen, carbon dioxide, oxygen, and fuel that is denoted as stream 5 in FIG. 1.

Alternatively, in one embodiment, no hydrocarbon fuel is added to the mixer, unit 2 so that stream 4 is not used in this embodiment. Hydrogen that was previously added can be used as the fuel for the combustor that reacts with the oxygen added to produce the heat required to further raise the temperature to a temperature that is suitable for the RWGS reactor inlet.

The mixing of the oxygen into a stream comprising hydrogen and other fuels can be critical inside unit 2. The stream with the fuel can be split so that each stream is present is a small channel, pore, or pipe. Stoichiometric amounts of oxygen can be added around channel such that the oxygen to fuel ratio is controlled to the desired ratio as per the combustion equation. The mixed fuel is stream 5 in FIG. 1.

Immediately downstream of the mixer is the oxy-fuel combustor or combustor reactor, unit 3. In the combustor reactor, the combustion reaction reaches completion, and the overall temperature of the stream is further raised to the RWGS reactor inlet temperature of 1200 to 2000° F. or more preferred temperature of 1650 to 1750° F. The combustor reactor is a refractory lined vessel to limit heat losses and to allow the use of standard metallurgy. The mixer may be inside the combustor vessel or immediately next to the combustor vessel. Leaving the oxyfuel combustor, unit 3, is stream 6, the RWGS reactor feed.

The fuel or fuel mixture added to the combustor is typically purified so that the combustion products do not have excessive levels of impurities like sulfur containing compounds, or nitrogen containing compounds that could contaminate the downstream RWGS catalyst.

In one embodiment of the invention, the main RWGS reactor vessel, unit 4, is a tubular reactor with a length longer than diameter. The entrance to the main reactor vessel is smaller than the overall diameter of the vessel. The main reactor vessel is a steel vessel. The steel vessel is insulated internally to limit heat loss. Various insulations including poured or castable refractory lining or insulating bricks may be used to limit the heat losses to the environment (Harbison-Walker Handbook of Refractory Practices, 2005). The reactor shell will be typical metallurgy for a cold wall vessel with a maximum external surface temperature of less than 400° F.

In another embodiment of the invention, the RWGS main reactor or reactors are not made with stainless steel or ceramic materials. The construction of the catalytic reactors with stainless steel or ceramic materials that contain silica are not acceptable since the silica has been found to react with the syngas to produce silicon hydride which then deposits silicates on the catalysts, significantly reducing the lifetime and efficiency of the RWGS catalyst as well as causing possible structural degradation of the reactor, which would have safety and operational implications. Stainless steel is also not acceptable since it reacts with the syngas. It is preferred that the catalyst reactors are manufactured from high-temperature Inconel or Hastelloy. In this embodiment, the inside surface of the Inconel or Hastelloy is lined with an insulating, non-reactive surface coating which does not react with the syngas and effect catalyst performance. Examples of acceptable surface coatings include spinels such as magnesium aluminate and yttria-stabilized zirconia (YSZ). These coatings may be applied using thermal spray processes.

A bed of catalyst is inside the main RWGS reactor vessel. The catalyst can be in the form of granules, pellets, spheres, trilobes, quadra-lobes, monoliths, or any other engineered shape to minimize pressure drop across the reactor. Ideally the shape and particle size of the catalyst particles is managed such that pressure drop across the reactor is less than 50 pounds per square inch (psi) [345 kPa] and more preferably less than 20 psi [139 kPa]. The size of the catalyst form can have a characteristic dimension of between 1 mm to 10 mm. The catalyst particle is a porous material with an internal surface area greater than 40 m²/g, more preferably greater than 100 m²/g. The packed catalyst can be arranged as a standard down flow, supported on ceramic balls or alternative designs may be considered such as radial flow. The key design factor for the catalyst bed is the minimization of pressure drop (above that needed for flow distribution) at the desired high GHSV design. In one embodiment, the proposed dimensions of 4 feet inner diameter by 4 feet deep bed of catalyst gives a Gas Hourly Space Velocity (GHSV) of approximately 26,000 h⁻¹ with a pressure drop through the support balls and catalyst of 6 psi (0.21 bar).

The conversion of carbon dioxide to carbon monoxide in the main RWGS reactor vessel is generally between 15 and 85 mole % and more preferably between 30 to 80 mole %. The Weight Hourly Space Velocity (WHSV) which is the mass flow rate of reactants (H₂+CO₂) per hour divided by the mass of the catalyst in the main reactor bed is between 0.1 and 10.0 hr⁻and more preferably 1.0 to 3.0 hr⁻¹.

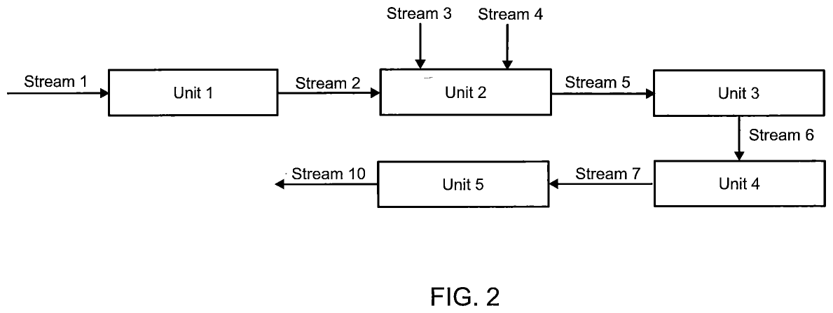

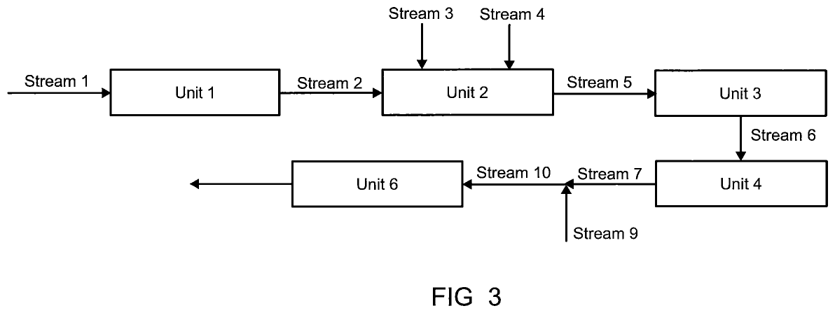

The RWGS reactor product, stream 7, leaves the RWGS reactor at a temperature less than the RWGS reactor inlet temperature, in the range of 1380° F. and 1500° F., more preferably about 1430° F. FIG. 2 shows one embodiment of the invention in that the RWGS reactor outlet stream, stream 7, is fed to a Liquid Fuel Production (LFP) reactor, Unit 5, in FIG. 3. The LFP reactor converts some of the carbon monoxide and hydrogen in stream 7 to hydrocarbons, denoted as stream 8 in FIG. 3.

To increase the overall conversion of carbon dioxide, additional RWGS reactors in series can be used. One reactor or multiple RWGS reactors will be operated in series to obtain the desired Carbon Dioxide conversion to carbon monoxide. FIG. 3 shows the addition of a 2^{nd} RWGS reactor, denoted as Unit 6. Without the addition of additional energy, the temperature at the outlet of the RWGS reactor will be lower than the inlet. Therefore, there is a need to add more energy between the 1st and 2nd RWGS reactor in series. The fuel oxidation and combustion system used prior to the first RWGS reactor can be used as interstage heating to raise the first RWGS outlet stream temperature to the RWGS reactor inlet temperature of 1200 to 2000° F. or the more preferred temperature of 1650 to 1750° F. FIG. 3 shows the addition of a stream comprising oxygen, stream 9, to the 1^{st} RWGS product, stream 7 that leads to combustion that raises the 2^{nd} RWGS reactor inlet temperature, stream 10, fed to Unit 6 in FIG. 3, to produce stream 11 in FIG. 3.

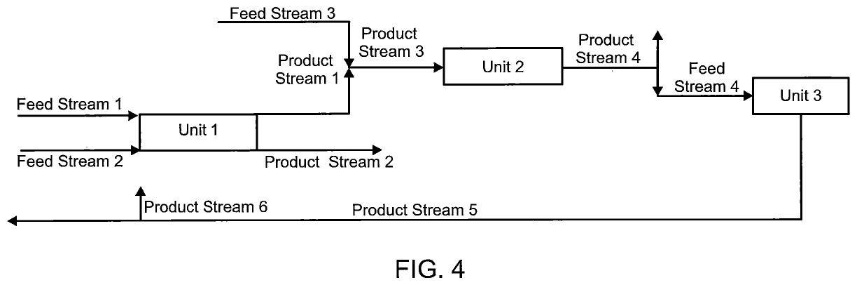

FIG. 4 shows an overall block flow diagram to produce hydrocarbons from low carbon electricity and carbon dioxide. Unit 1 is an electrolyzer that uses low carbon electricity and water to produce a stream comprising hydrogen, product stream 1, and a stream comprising oxygen, product stream 2. A stream comprising hydrogen, product stream 1, and a stream comprising carbon dioxide, feed stream 3, are blended together to create a RWGS reactor feed, product stream 3, in FIG. 4. Unit 2 is a RWGS reactor that produces RWGS Product stream, Product stream 4.

At least a portion of stream 4 is used as feed to the LFP reactor, Unit 3, in FIG. 4. The LFP reactor produces at least two hydrocarbon products, one gaseous, called LFP tail gas, that is labeled Product Stream 6 and a liquid LP hydrocarbon product, Product Stream 5.

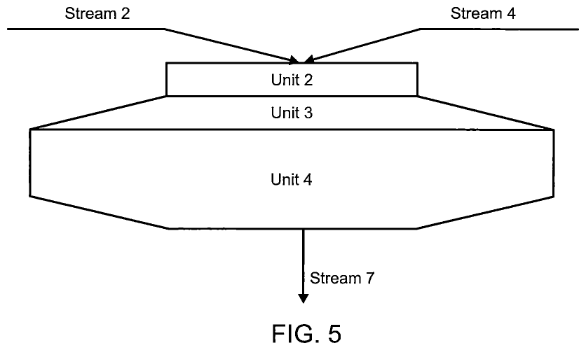

FIG. 5 shows one embodiment of the invention where the mixer, unit 2, combustor, unit 3, and RWGS reactor, unit 4, are integrated into a single vessel. In this case, stream 2, a RWGS feed stream, is blended with fuel, stream 4. A stream comprising oxygen is fed to the mixer, unit 3. In the attached combustor, unit 3, the fuel and/or hydrogen is combusted to raise the temperature of the stream to the RWGS reactor inlet conditions. The hot gas is immediately fed to the attached RWGS reactor to produce an RWGS reactor product stream, stream 7. The advantage of this system is that 3 separate vessels are integrated into a single vessel. The entire system is refractory lined and heat losses are minimized.

In another embodiment of the invention, the hydrogen and carbon dioxide are not mixed prior to heating to the RWGS reactor inlet temperature and are not mixed until the hydrogen and carbon dioxide streams are fed to the RWGS reactor. This is done to minimize any possible reaction between the hydrogen and carbon dioxide or other materials that are in either stream. In this embodiment, at least one of the streams is heated to a temperature at or near the RWGS reactor inlet temperature by an oxy-fuel combustion process prior to being fed into the RWGS reactor.

The RWGS reactor or reactors produce a stream that comprises hydrogen and carbon monoxide or syngas. At least a portion of RWGS product becomes the Liquid Fuel Production (LFP) reactor feed. With the possible addition of extra hydrogen, the syngas is reacted to fuels and chemicals in a Liquid Fuels Production (LFP) reactor (Unit 3 in FIG. 4 or Unit 5 in FIG. 2) that uses a catalyst to produce long chain hydrocarbons that are used as fuels and chemicals. The final product of the LFP reactor is a hydrocarbon mixture where the majority (e.g., 51 volume percent to 99 volume percent) of hydrocarbons in the mixture are hydrocarbons from 5 to 24 carbon atoms in length.

The LFP feed stream comprising hydrogen and carbon monoxide enter the LFP reactor. The LFP reactor is a multi-tubular fixed bed reactor that allows the Fischer-Tropsch (F-T) reaction of Eq. 8.

$$nCO + ( 2 n + 1 ) {H}_{2} \to {C}_{n} {H}_{2 n + 2} + {nH}_{2} O Δ {H}_{0} = - 165 \frac{kJ}{mol CO} \qquad Eq . 4$$

The F-T reaction is exothermic with a standard enthalpy of reaction released of 165 kJ/mol of CO converted. The high heat of reaction makes control of the LFP reactor temperature critical. If uncontrolled, the temperature rise in the reactor would result in higher methane production and higher catalyst deactivation, as such control of the temperature is important. Ideally the temperature of the LFP or F-T reactor is maintained at 200 to 240° C.

The multi-tubular fixed bed reactor aids in the control of the temperature of the LFP reactor. Syngas is fed to the reactor and is split to go through the tubular catalytic reactors. The syngas reactor produces a mixture primarily consisting of alkanes, alkenes, and alcohols as shown by the F-T reaction (Eq. 4). The mixed hydrocarbons, Product Stream 5 in FIG. 4, leaves the tubular reactor. Additionally, water is produced by the reaction, as shown in Eq. 4. The water produced in the LFP reaction can be knocked out of the LFP product stream and used for other purposes including

The LFP reactor also produces a gaseous product called LFP tail gas, Product Stream 6 in FIG. 4 that comprises unreacted hydrogen and carbon monoxide as well as light hydrocarbons with carbon numbers from 1 to 4.

A portion of the LFP tail gas stream can be used as fuel in the combustor. The amount of LFP tail gas added to the fuel steam in the combustor may be controlled by the desired outlet temperature from the combustor unit. A portion of the LFP tail gas can be used as feedstock to an autothermal reformer (ATR) that converts the light hydrocarbons to syngas that can be used as feed to the LFP reactor.

The LFP hydrocarbon product stream comprises n-alkanes with carbon numbers from 5 to 24 that is fed to an LFP separation unit where at least three products are produced. “Carbon number” refers to the number of carbon atoms in the respective alkane. The LFP separation is any separation process absorption, adsorption, filtration, or distillation. Distillation is the preferred separation process. The LFP separation unit produces at least three products. The light LFP separation product comprises n-alkanes with carbon numbers between 5 and 8. The heavy LFP separation product comprises n-alkanes with carbon numbers between 16 and 24. The medium LFP separation product comprises n-alkanes from carbon numbers between 9 and 15. The medium LFP separation product is in the boiling range of synthesized paraffinic kerosene or jet fuel. The physical properties of the n-alkane rich medium LFP separation product do not meet the requirements of SPK jet fuel without additional processing.

In one embodiment of the invention, at least a portion of the heavy LFP separation unit product is sold as premium low sulfur, high cetane diesel fuel that meets ASTM D975 specification for diesel fuel. “At least a portion of” means a part of the whole. Nonlimiting examples of “at least a portion” include 5%, 10%, 20%, 30%, 40%, 50%, 60%, 70%, 80%, 90% and 100%.

In one embodiment, it is desirable to produce sustainable aviation fuel (SAF) that meets jet, fuel specifications such as ASTM D7566 as the product produced by the process. In that embodiment, at least a portion of the medium LFP separation product is fed to a hydroisomerization unit. In hydroisomerization, the properties of the feedstock are improved by transforming normal alkane hydrocarbons to branched ones having the same carbon numbers. This reaction improves the cold flow properties of the hydrocarbon. The hydroisomerization reaction decreases the pour point or the freezing point of the hydrocarbon stream.

The hydroisomerization reactor is any suitable design but it is preferred that the reactor be a cylindrical reactor with a liquid feed at the top of the reactor. The liquid feed comprising the medium LFP separation product is mixed with a stream comprising hydrogen. The combined feed reacts over a catalyst bed in the reactor vessel. Typically, this reactor is a trickle bed reactor. At least a portion of the n-alkanes react across the catalyst to produce branched alkanes. The reactor is comprised of one or more catalyst beds. In some embodiments, additional hydrogen feed is injected between the various catalyst beds. The molar ratio of the hydrogen to liquid hydrocarbon feed ranges from 10 to 300, more preferably between 15 to 30, even more preferably from 19 to 25. The operating pressure of the hydroisomerization reactor is between 10 to 100 bar, more preferably between 20 and 80, and more preferably between 30 and 40. The Weight Hourly Space Velocity (WHSV) is between 0.1 to 10 kg/hr liquid feed/kg catalyst, more preferably between 0.2 and 5 hr⁻¹, and more preferably between 0.5 to 2 hr⁻¹. The reactor operating temperature from 200° C. to 350° C.

The hydroisomerization catalyst is a solid shaped particle. The catalyst comprises a metal deposited on an acidic support. The catalyst metal in some embodiments is a platinum and palladium that provides hydrogenation and dehydrogenation activity. The catalyst metal in some embodiments comprises nickel. The catalyst metal in some embodiments comprises copper. In some embodiments that catalyst metal comprises a bimetallic such as Ni—Cu, Ni—Mo, Pt—Fe, and Pt—Be. The acidic support is chosen from any suitable support and includes supports comprising ZSM-5, ZSM-22, ZSM-23, Silica, Alumina, SiO₂—Al₂O₃, Beta zeolite, MCM-41, MCM-48, SBA-15 and includes blends of such supports.

The conversion of n-alkane to branched alkane in the hydroisomerization reactor is preferably between 50 and 100%, and more preferably from 80 to 100%. The reactor temperature, pressure, hydrogen to n-alkane ratio, and weight hourly space velocity (WHSV) is manipulated to maintain a high conversion of n-alkane conversion to branched alkanes.

In some embodiments of the invention, a least a portion of the light LFP separation unit product comprising a mixture of alkanes and alkenes is fed to an oligomerization reactor to produce an oligomerization product.

The light LFP separation unit product comprises a mixture of n-alkanes and n-alkenes. The alkene/alkane ratio in the stream is controlled by changes in the LFP reactor operating conditions. Lower hydrogen to carbon monoxide ratios in the LFP reactor feed and higher LFP reactor temperature favors the production of n-alkenes over n-alkanes. The alkenes are reacted with each other and produce a product that is in the kerosene boiling range.

Oligomerization refers to one or more consecutive addition reactions between alkenes. Alkene addition is collectively referred to as oligomerization unless it is important to indicate a specific multiple of the addition reaction. It is a catch-all term that includes dimerization (addition reaction of two alkenes), trimerization, tetramerization, and higher multiples of addition reactions.

The oligomerization reactor is a fixed bed reactor filled with catalyst. The reactor operates at a temperature of 100° C. to 300° C. at a pressure of 8 to 70 bar. A wide range of different catalyst are used to oligomerize the n-alkenes in the oligomerization reactor. These catalysts include SO₄²⁻/ZrO₂, H-ZSM-5, H—Y, Cr/H-ZSM-5, Cr/H—Y, Cr/H-MCM-41, Solid Phosphoric Acid (SPA), metal promoted SPA catalyst, Fe/NiO/SPA, amorphous SiO₂—Al₂O₃, H-ZSM-22, H-ZSM-57, Cr/SO2, H₃PO₄/SO₂, and other commercial catalysts.

By the nature of the oligomerization reaction, the linear alkenes produced in the LFP reactor when oligomerized become primarily branched alkenes. These branched oligomers will primarily be dimers and trimers of the feed alkenes. The branched products are alkenes primarily but with certain metal promoted oligomerization catalysts, the alkenes produced by oligomerization are hydrogenated to alkanes in the oligomerization reactor.

Kerosene and diesel range material is produced by oligomerization. The distillate properties depend on the catalyst technology that is used. When ZSM-5-catalyzed oligomerization is employed, the branching in the distillate is limited and the hydrogenated distillate has a high cetane number and good cold-flow properties.

There are commercially available oligomerization technologies currently available that are used to convert the alkenes in the light LFP separation unit product to kerosene boiling range hydrocarbons. These commercial technologies include UOP Cat Poly which uses Solid Phosphoric Acid (SPA) catalysts; Axens Polynaphtha that uses amorphous silica-alumina; PetroSA COD technology that uses H-ZSM-5 zeolite; ExxonMobil MOGD or Emogas technology that uses H-ZSM-5 zeolite, H-ZSM-22 zeolite, or H-ZSM-57.

In one embodiment, at least a portion of the oligomerization reactor product is recycled to the LFP separation unit. The oligomerized portion of the stream has a boiling point range that primarily results in the oligomers to be in the medium LFP separation unit product and will then go the hydroisomerization reactor Alkenes from the oligomerization reactor are hydrogenated to alkanes in the hydroisomerization reactor.

In one embodiment, the heavy hydroisomerization product instead of being sold as a diesel fuel is sent to a hydrocracker reactor to increase the kerosene or jet fuel yield. Hydrogen is also added to the hydrocracker reactor. Unlike standard petroleum refining hydrocracker, the hydrocracker is operated at generally lower severity (temperature and pressure) than a petroleum refining unit that is used to convert vacuum gas oil to diesel fuel. This is because the heteroatom level (S, N) in the hydrocracker feedstock is very low, and the feedstock carbon number distribution is in the range of C₁₆-C₂₄ instead of the C₄₄₊ that is common in petroleum vacuum gas oil. The operating pressure of the hydrocracker is from 10 to 70 bar and more preferably from 25 to 35 bar. The operating temperature of the reactor is from 250 to 380° C.

Hydrocracking catalysts must have metal and acid sites. Many different catalysts have been investigated for n-alkane hydrocracking in general and for Fischer-Tropsch hydrocracking in particular. Based on the metal functionality, there are two major classes of catalysts that are relevant for the hydrocracking of these materials:
1. Sulfided base metals on acidic support materials. These are typical crude oil hydrocracking catalysts and require the addition of a sulfiding agent to keep the metals in their sulfided state. Such catalysts are industrially applied in some Fischer-Tropsch facilities with syncrudes. The catalysts of this type that have most often used are NiMo and NiW on amorphous silica alumina (ASA).
2. Unsulfided noble metal catalysts. Hydrocracking catalysts based on Pt/SiO₂—Al₂O₃ were found to be very good for this hydrocracking application, and higher distillate selectivities are obtained at high conversion than over sulfided base metal catalysts. However, because of the Pt, the costs of these catalyst are higher.

The hydrocracker reactor is operated at the minimum severity required to convert the C₁₆-C₂₄ material to a C₉-C₁₅ fraction. The hydrocracker product stream is sent to the Hydrocracker Product Separation Unit where the light gases (H₂, C₁-C₄) are flashed off. The heavy hydrocracker product separation unit that comprises hydrocarbons with carbon numbers from 5 to 15. At least a portion of the Heavy Hydrocracker Product Separation Stream is sent back the LFP Separation Unit.

The SPK jet fuel meets the ASTM D7566 specification for synthetic jet fuel blend component and is carbon neutral and has a well-to-wheels CO2 emission of between 0 and 10 gCO₂eq/MJ. This emissions factor is known as the carbon intensity. The well-to-wheel emissions include all emissions related to the fuel production, processing, distribution, and use. Tools such as CA-GREET 3.0 (reference 4) can be used to calculate the overall carbon intensity.

### EXAMPLES

A heated RWGS feed stream comprising hydrogen and carbon dioxide is heated to 650° F. by a heat exchanger using RWGS product as the heating medium. A process simulation of oxygen co-injection was performed with various scenarios as an example of the invention. The combustor outlet temperature and therefore the RWGS reactor feed temperature was held constant in each example at 1670° F. The base hydrogen to carbon dioxide ratio in feed (stream 1) is held constant at 2.0. The added hydrogen for combustion is in excess of the amount required to hold the H₂/CO₂ ratio constant.

### Example 1

The fuel feed rate mass flow rate (Stream 2 in FIG. 1) is set to 0. Added hydrogen is added to Stream 1. The added hydrogen is 1000 kg/hr. The added hydrogen is combusted in the oxyfuel combustor (Unit 3) with the added oxygen (stream 3) that is added to the mixer.

### Example 2

The fuel feed rate mass flow rate (Stream 2 in FIG. 1) is set to 200 kg/hr of methane or natural gas of LFP tail gas. Added hydrogen is added to Stream 1 to aid in the combustor. The added hydrogen is 900 kg/hr. The added hydrogen and the fuel are combusted in the oxyfuel combustor (Unit 3) with the added oxygen (stream 3) that is added to the mixer.

### Example 3

The fuel feed rate mass flow rate (Stream 2 in FIG. 1) is set to 400 kg/hr of methane or natural gas. Added hydrogen is added to Stream 1 to aid in the combustor. The added hydrogen is 700 kg/hr. The added hydrogen and the fuel are combusted in the oxyfuel combustor (Unit 3) with the added oxygen (stream 3) that is added to the mixer.

### Example 4

The fuel feed rate mass flow rate (Stream 2 in FIG. 1) is set to 600 kg/hr of methane. Added hydrogen is added to Stream 1 to aid in the combustor. The added hydrogen is 600 kg/hr. The added hydrogen and the fuel are combusted in the oxyfuel combustor (Unit 3) with the added oxygen (stream 3) that is added to the mixer.

### Example 5

The fuel feed rate mass flow rate (Stream 2 in FIG. 1) is set to 800 kg/hr of methane. Added hydrogen is added to Stream 1 to aid in the combustor. The added hydrogen is 400 kg/hr. The added hydrogen and the fuel are combusted in the oxyfuel combustor (Unit 3) with the added oxygen (stream 3) that is added to the mixer.

### Example 6

The fuel feed rate mass flow rate (Stream 2 in FIG. 1) is set to 900 kg/hr of methane. Added hydrogen is added to Stream 1 to aid in the combustor. The added hydrogen is 300 kg/hr. The added hydrogen and the fuel are combusted in the oxyfuel combustor (Unit 3) with the added oxygen (stream 3) that is added to the mixer.

### Example 7

The fuel feed rate mass flow rate (Stream 2 in FIG. 1) is set to 1100 kg/hr of methane. Added hydrogen is added to Stream 1 to aid in the combustor. The added hydrogen is 150 kg/hr. The added hydrogen and the fuel are combusted in the oxyfuel combustor (Unit 3) with the added oxygen (stream 3) that is added to the mixer.

### Example 8

The fuel feed rate mass flow rate (Stream 2 in FIG. 1) is set to 1300 kg/hr of methane. In this example, no additional hydrogen is added to the feed stream for combustion. The added hydrogen and the fuel are combusted in the oxyfuel combustor (Unit 3) with the added oxygen (stream 3) that is added to the mixer.

TABLE 1
shows the summary of the examples.

| Example | Extra Hydrogen Flow | Methane Flow Rate |
|---|---|---|
| Number | Rate (kg/hr) | (kg/hr) |
| 1 | 1000 | 0 |
| 2 | 900 | 200 |
| 3 | 700 | 400 |
| 4 | 600 | 600 |
| 5 | 400 | 800 |
| 6 | 300 | 900 |
| 7 | 150 | 1100 |
| 8 | 0 | 1300 |

### Example 9

The hydrogen and carbon dioxide are not mixed prior to heating to the RWGS reactor inlet temperature and are not mixed until the hydrogen and carbon dioxide streams are fed to the RWGS reactor. This is done to minimize any possible reaction between the hydrogen and carbon dioxide or other materials that are in either stream. In this case, the carbon dioxide containing stream has a sulfur containing impurity. A hydrodesulfurization (HDS) and adsorption design is used. The first step involves the hydrogenation of the hydrogen sulfur species to H₂S. This occurs over a molybdenum containing catalyst in the range of 650° F. to 750° F. A small amount of hydrogen from the electrolyzer is mixed with the carbon dioxide containing stream in an amount of 2 mol % and the stream is heated to about 700° F. using a cross exchange with the RWGS exiting syngas. The carbon dioxide stream is passed across the HDS catalyst to convert all sulfur containing compounds to hydrogen sulfide. The hydrogen sulfide is removed in an adsorption bed comprising ZnO downstream of the HDS reactor. To remove hydrocarbon species from the hot CO₂ leaving the ZnO beds, an oxidation or oxycombustion step is used. Oxygen from the electrolyzer is mixed with the carbon dioxide stream to combust hydrocarbons and possible hydrogen into additional carbon dioxide. This also heats the carbon dioxide stream up to the RWGS inlet temperature of 1650° F. If there are is not sufficient hydrocarbon or hydrogen in the carbon dioxide stream, additional fuel and oxygen can be added to obtain the desired temperature rise in the carbon dioxide stream. In this example, the hydrogen is heated to the RWGS inlet temperature by use of an electric heater. The carbon dioxide and hydrogen react to produce carbon monoxide in the RWGS reactor.

### REFERENCES

[1] S. Adelung, S. Maier, R. Dietrich, “Impact of the reverse water gas shift operating conditions on the Power-Liquid process efficiency”, Sustainable Energy Technologies and Assessments 43 (2021) 100897.
[2] S. Adelung, R. Dietrich, “Impact of the reverse water-gas shift operating conditions on the Power-to-Liquid fuel production cost”, Fuel 317, 1 June 2022, 123440.

1. A method for heating a carbon dioxide stream for the production of syngas for use in the production of renewable fuels and chemicals comprising:
a. heating a RWGS feed stream comprising carbon dioxide and hydrogen to a first temperature in a heat exchanger to produce a heated RWGS feed stream at a second temperature, wherein the second temperature is greater than the first temperature;
b. mixing a stream comprising oxygen with the heated RWGS feed stream at the second temperature in an oxyfuel combustor, thereby causing a combustion reaction that produces a RWGS feed stream at a third temperature, wherein the third temperature is higher than the second temperature
c. feeding the RWGS at the third temperature to a RWGS reactor, thereby producting a RWGS product stream comprising carbon monoxide, and wherein the RWGS product stream is at a fourth temperature, and wherein the fourth temperature is lower than the third temperature.

2. The process of claim 1 wherein a stream comprising fuel is mixed with the stream comprising oxygen and the heated RWGS feed stream at the second temperature in the oxyfuel combustor.

3. The process of claim 2 wherein the fuel is chosen from LFP tail gas, natural gas, renewable natural gas, biomass derived syngas, LFP naphtha, LPG, carbon monoxide, or hydrogen.

4. The process of claim 1 wherein the RWGS product stream comprises a mixture of hydrogen and carbon monoxide and at least a portion of RWGS product stream is further processed in a Liquid Fuel Production reactor to produce a stream comprising a liquid hydrocarbon, wherein at least one component of the liquid hydrocarbon is an alkane with a carbon number between 5 and 24.

5. The process of claim 4 wherein the liquid hydrocarbon is further processed to produce a diesel fuel that meets ASTM D975.

6. The process of claim 4 wherein the liquid hydrocarbon is further processed to produce a jet fuel component that meets ASTM D7566.

7. The process of claim 1 where the first temperature is between 70 and 200° F.

8. The process of claim 7 where the second temperature is between 649° F. to 1001° F.

9. The process of claim 8 where the third temperature is between 1650° F. to 1750° F.

10. The process of claim 9 where the fourth temperature is between 1400° F. to 1500° F.

11. The process of claim 10 wherein the RWGS product stream is mixed with a stream comprising oxygen in an oxyfuel combustor to cause a combustion reaction that produces a heated second RWGS reactor feed stream that is fed to a second RWGS reactor at a fifth temperature wherein the fifth temperature is higher than the RWGS product stream temperature.

12. The process of claim 11 wherein the fifth temperature is between 1650° F. to 1750° F.

13. The process of claim 1 where the oxygen is produced in an electrolyzer.

14. A process for the production of syngas comprising:
a. heating a RWGS feed stream comprising carbon dioxide and hydrogen at a first temperature in a heat exchanger to produce a heated RWGS feed stream at a second temperature, wherein the second temperature is greater than the first temperature;
b. mixing the RWGS feed stream at the second temperature with a stream comprising oxygen in an oxyfuel combustor, thereby causing a combustion reaction producing a RWGS feed stream at a third temperature, wherein the third temperature is higher than the second temperature;
c. feeding the RWGS feed stream at a third temperature to a RWGS reactor, thereby producing an RWGS product stream comprising carbon monoxide at a fourth temperature, wherein the fourth temperature is lower than the third temperature.
